(19) United States
(12) Patent Application Publication
(10) Pub. No.: US 2019/0355072 A1
(43) Pub. Date: Nov. 21, 2019

(54) MANAGEMENT SERVER, INFORMATION PROCESSING METHOD, AND INFORMATION PROCESSING SYSTEM

(71) Applicant: TOYOTA JIDOSHA KABUSHIKI KAISHA, Toyota-shi (JP)

(72) Inventors: Nariaki AMANO, Tokyo-to (JP); Naoki YAMAMURO, Nagoya-shi (JP); Masato ENDO, Nagakute-shi (JP); Yukiya YAMANE, Koto-ku (JP)

(73) Assignee: TOYOTA JIDOSHA KABUSHIKI KAISHA, Toyota-shi (JP)

(21) Appl. No.: 16/416,908

(22) Filed: May 20, 2019

(30) Foreign Application Priority Data
May 21, 2018 (JP) 2018-097061

(51) Int. Cl. G06Q 50/06; G06Q 30/02; G06Q 30/04; B60L 53/66

(52) U.S. Cl. CPC G06Q 50/06; G06Q 30/0283; B60Y 2300/91; B60L 53/665; B60Y 2200/91; G06Q 30/04

(57) ABSTRACT

In a management server, a billing processing unit performs billing processing of a certain amount of fee for a user at certain timing. An acquirer acquires charge result information of a vehicle of the user charged up with electricity supplied through an electric outlet. A deriver derives an amount of payment to a manager of the installation place of the electric outlet based on the charge result information acquired at the acquirer.

The disclosure of Japanese Patent Application No. 2018-097061 filed on May 21, 2018 including the specification, drawings and abstract is incorporated herein by reference in its entirety.

### BACKGROUND

### 1. Technical Field

The present disclosure relates to a management server, an information processing method, and an information processing system for managing information regarding electricity trade.

### 2. Description of Related Art

There are known systems that enable drivers of electric vehicles to charge up the batteries of their electric vehicles using electric outlets installed in houses or stores where they are visiting. JP-A-2010-079456 discloses an electricity bill charging system in which a center device notifies an electricity supplier having a contract with the owner of a vehicle, of information on the amount of electricity supplied to the vehicle through an electric outlet at an electricity supply place. In this system, the owner of the vehicle is directly charged a fee corresponding to the amount of electricity supplied to the vehicle, and a manager of the electricity supply place is charged a fee for a difference amount of electricity calculated by subtracting the amount of electricity supplied to the vehicle.

As a method for charging a fee, flat-rate pricing can be considered. The inventors have found that, when flat-rate pricing is employed for charging to users who charge up their vehicle batteries using an electric outlet, how to perform payment to a manager of the installation place of the electric outlet would be a problem.

### SUMMARY

The present embodiments address the above-described issue, and a general purpose thereof is to provide a management server, an information processing method, and an information processing system capable of appropriately performing payment to a manager of the installation place of an electric outlet while flat-rate pricing is employed for charging to users.

In response to the above issue, a management server of one aspect of the present embodiments includes: a billing processing unit configured to perform billing processing of a predetermined amount of fee for a user at predetermined timing; an acquirer configured to acquire charge result information of a vehicle of the user charged up with electricity supplied through an electric outlet; and a deriver configured to derive an amount of payment to a manager of the installation place of the electric outlet on the basis of the charge result information acquired at the acquirer.

According to this aspect, since billing processing of a predetermined amount of fee is performed for a user and an amount of payment to a manager of the installation place of the electric outlet is derived based on the charge result information, the payment to the manager can be appropriately performed.

The billing processing unit may perform billing processing of the predetermined amount of fee for each of a plurality of users at the predetermined timing. The acquirer may acquire the charge result information for each of a plurality of electric outlets. On the basis of the charge result information for each of the plurality of electric outlets acquired at the acquirer, the deriver may distribute an amount corresponding to the total amount of fees of which billing processing has been performed for the plurality of users, among managers of the installation places of the respective electric outlets, and may set the amount distributed to each manager as an amount of payment to the manager.

Each manager may be charged, by an electricity supplier for supplying electricity to the electric outlet, an electricity fee for electricity supplied to the vehicle through the electric outlet. For each manager, when the amount distributed to the manager is less than the electricity fee charged to the manager, the deriver may add the difference between the electricity fee and the amount distributed to the manager, to the amount of payment to the manager.

Another aspect of the present embodiments relates to an information processing method. The information processing method includes: performing billing processing of a predetermined amount of fee for a user at predetermined timing; acquiring charge result information of a vehicle of the user charged up with electricity supplied through an electric outlet; and deriving an amount of payment to a manager of the installation place of the electric outlet on the basis of the charge result information acquired.

According to this aspect, since billing processing of a predetermined amount of fee is performed for a user and an amount of payment to a manager of the installation place of the electric outlet is derived based on the charge result information, the payment to the manager can be appropriately performed.

Yet another aspect of the present embodiments relates to an information processing system. The information processing system includes an electricity supply device, and a management server configured to communicate with the electricity supply device. The electricity supply device includes: an electric outlet through which electricity supplied from an electricity supplier can be supplied to a vehicle of a user; and a control device configured to record charge result information of the vehicle charged up with electricity supplied through the electric outlet. The management server includes: a billing processing unit configured to perform billing processing of a predetermined amount of fee for the user at predetermined timing; an acquirer configured to acquire the charge result information from the control device; and a deriver configured to derive an amount of payment to a manager of the installation place of the electric outlet on the basis of the charge result information acquired at the acquirer.

According to this aspect, since billing processing of a predetermined amount of fee is performed for a user and an amount of payment to a manager of the installation place of the electric outlet is derived based on the charge result information, the payment to the manager can be appropriately performed.

The information processing system may further include a fee charging server configured to derive an electricity fee of the installation place of the electric outlet. While electricity is supplied to the vehicle through the electric outlet, the control device may transmit battery charging information to the fee charging server. The fee charging server may derive an electricity fee for electricity used while the battery charging information is received, on the basis of a second unit price that is lower than a first unit price applied when the battery charging information is not received.

### BRIEF DESCRIPTION OF THE DRAWINGS

Embodiments will now be described, by way of example only, with reference to the accompanying drawings that are meant to be exemplary, not limiting, and wherein like elements are numbered alike in several figures, in which:

FIG. 1 is a block diagram that shows a configuration of an information processing system according to a first embodiment;

FIG. 2 is a block diagram that shows a configuration of a management server shown in FIG. 1; and

FIG. 3 is a sequential diagram that shows processing performed in the information processing system shown in FIG. 1.

### DETAILED DESCRIPTION

Various embodiments now will be described. The embodiments are illustrative and are not intended to be limiting.

### First Embodiment

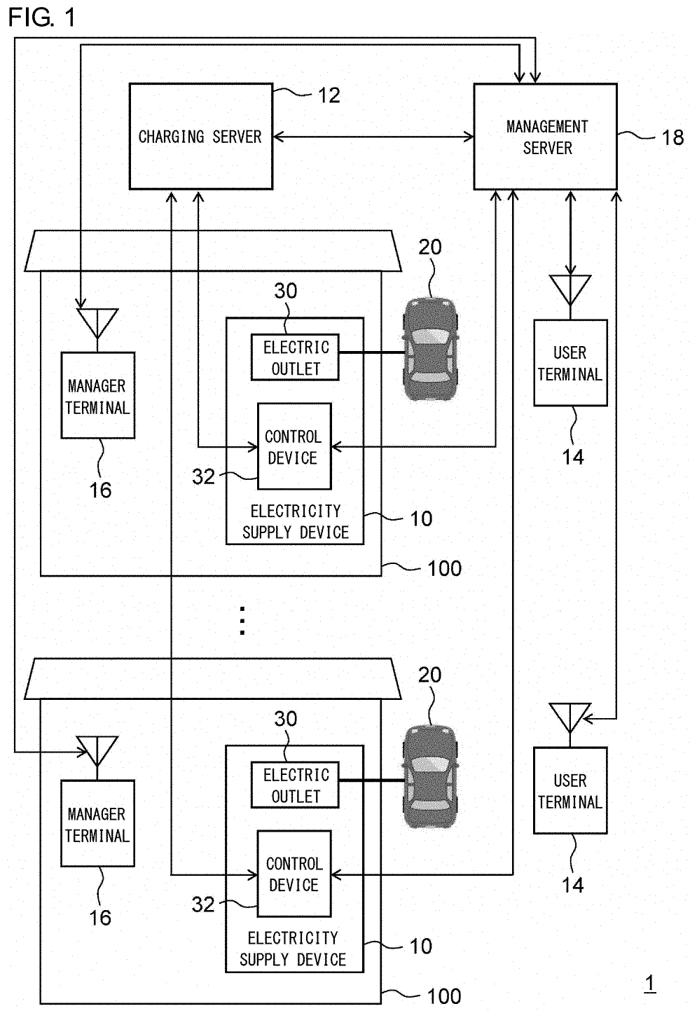

FIG. 1 shows a configuration of an information processing system 1 according to the first embodiment. The information processing system 1 includes multiple electricity supply devices 10, a fee charging server 12, multiple user terminals 14, multiple manager terminals 16, and a management server 18.

Each electricity supply device 10 may be installed in a store, a house, a company, a parking area, and other facilities, for example, and is capable of supplying electricity to a vehicle 20 owned by one of multiple users registered in advance in the management server 18. The electricity supply devices 10 are also called authentication outlets. Each electricity supply device 10 includes an electric outlet 30 and a control device 32. A facility where an electricity supply device 10 is installed is referred to as an installation place 100 of an electric outlet 30.

To an electric outlet 30, electricity is supplied from an electricity supplier, such as an electricity company. Also, to an electric outlet 30, a vehicle 20 of a user can be electrically connected using a charging cable. Each vehicle 20 may be an electric vehicle, a hybrid vehicle, or the like that includes an electric motor for generating vehicle drive power, and a secondary battery for storing electricity used to drive the electric motor. Electricity is supplied to a vehicle 20 through an electric outlet 30, and the secondary battery mounted on the vehicle 20 is charged up therewith. Each control device 32 performs wired communication or wireless communication with the management server 18 and the fee charging server 12, and also controls the electricity supply through a corresponding electric outlet 30.

The user terminals 14 are owned by the users of the vehicles 20. The user terminals 14 may be mobile terminals, such as smartphones, cellular phones, tablet terminals, notebook computers, and wearable terminals, or may be vehicle-mounted terminals configured as car navigation systems, for example.

Each user terminal 14 performs wireless communication with the management server 18. Based on information received from the management server 18, each user terminal 14 displays information regarding multiple electric outlets 30 near the current position, for example. The information regarding an electric outlet 30 includes a position, a chargeable time period, and the likes. Each user terminal 14 can accept a user's entry of a use request for an electric outlet 30. The use request includes information for identifying the electric outlet 30 specified by the user, for example. The user terminal 14 then transmits the use request thus accepted to the management server 18. To the use request, information for identifying the user is attached.

The management server 18 may be installed in a data center, for example, and functions as an information processing device for processing information transmitted from the multiple user terminals 14 and the multiple electricity supply devices 10 to perform user authentication processing, payment processing, and the like. According to the use request transmitted from the user terminal 14, the management server 18 transmits an unlocking request to the electricity supply device 10 that includes the electric outlet 30 specified by the user. The configuration of the management server 18 will be described later.

Upon reception of the unlocking request from the management server 18, the control device 32 unlocks the electric outlet 30. While the electric outlet 30 is locked, even though a vehicle 20 is connected to the electric outlet 30, the control device 32 inhibits electricity supply through the electric outlet 30.

The user connects the vehicle 20 to the electric outlet 30 with a charging cable. When the vehicle 20 is connected to the electric outlet 30 while the electric outlet 30 is unlocked, the control device 32 starts electricity supply to the vehicle 20 through the electric outlet 30. While electricity is supplied to the vehicle 20 through the electric outlet 30, the control device 32 transmits battery charging information to the management server 18 and the fee charging server 12. The battery charging information is information indicating that the vehicle 20 is currently charged up with electricity supplied through the electric outlet 30. While electricity is supplied to the vehicle 20 through the electric outlet 30, the control device 32 may transmit the battery charging information to the management server 18, and the management server 18 may transmit the received battery charging information to the fee charging server 12.

When a predetermined period of time elapses after the start of battery charge, when the secondary battery of the vehicle 20 is fully charged, or when the user disconnects the charging cable from the electric outlet 30, for example, the control device 32 terminates the electricity supply to the vehicle 20 through the electric outlet 30 and locks the electric outlet 30. After the locking, the control device 32 transmits locking information to the management server 18.

Upon reception of the locking information, the management server 18 acquires charge result information based on the received battery charging information and derives an amount of payment to a manager based on the charge result information to perform payment processing. The charge result information includes a charging time for which the battery charging information has been received. The management server 18 transmits, to a corresponding manager terminal 16, payment completion information for the amount of payment to the manager and also transmits, to the fee charging server 12, the payment completion information indicating the completion of the payment processing for the manager.

The fee charging server 12 may be installed in a data center of an electricity supplier, for example. The fee charging server 12 derives an electricity fee of the installation place 100 of an electric outlet 30. The fee charging server 12 derives an electricity fee for a predetermined amount of electricity used while the battery charging information is received, based on a second unit price that is lower than a first unit price applied when the battery charging information is not received. The electricity fee thus derived is set as the electricity fee for the electricity used for the battery charge of the vehicle 20. The predetermined amount of electricity is appropriately determined based on the electricity used for battery charge of the vehicle 20. Thus, the second unit price applied to a fee for electricity used for battery charge of the vehicle 20 is lower than the first unit price applied to a fee for electricity consumed for electrical equipment other than the electricity supply device 10 in the installation place 100 of the electric outlet 30. The second unit price may be set in the contract between the electricity supplier and the owner of the management server 18, i.e., the provider of the battery charging service, for example.

The electricity fee for electricity used for battery charge of the vehicle 20 is charged to the owner of the management server 18, instead of to the manager. The owner of the management server 18 is charged accumulated electricity fees for electricity supplied to multiple vehicles 20 through multiple electric outlets 30 every predetermined period, such as once a month. The electricity fee for electricity other than that used for the battery charge of the vehicles 20 is charged to the manager.

The manager terminals 16 are terminals used by managers. The manager terminals 16 may be mobile terminals, such as smartphones, cellular phones, tablet terminals, notebook computers, and wearable terminals, or may be stationary terminals, such as personal computers. Each manager terminal 16 performs wireless communication with the management server 18. After the completion of battery charge for a user, the manager terminal 16 receives the payment completion information from the management server 18.

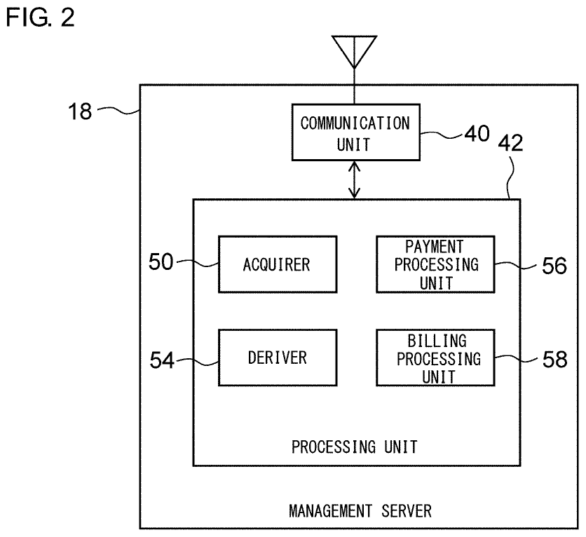

FIG. 2 shows a configuration of the management server 18 shown in FIG. 1. The management server 18 includes a communication unit 40 and a processing unit 42. The processing unit 42 includes an acquirer 50, a deriver 54, a payment processing unit 56, and a billing processing unit 58.

The billing processing unit 58 performs billing processing of a predetermined amount of fee for each of multiple users at predetermined timing. The predetermined timing may be once a month, for example. In this case, billing processing of a monthly flat-rate fee will be performed. The billing processing may be performed based on a well-known technology.

The communication unit 40 performs wireless communication with the multiple user terminals 14. The communication unit 40 also performs wired communication or wireless communication with the multiple manager terminals 16 and the multiple electricity supply devices 10. The communication unit 40 receives the use request from a user terminal 14 and outputs the use request thus received to the processing unit 42. According to the information for identifying the user attached to the use request, the processing unit 42 performs user authentication. Upon completion of the user authentication, based on the information for identifying the electric outlet 30 included in the use request, the processing unit 42 transmits, via the communication unit 40, the unlocking request to the electricity supply device 10 that includes the electric outlet 30 specified by the user.

The communication unit 40 receives the battery charging information from the electricity supply device 10 that includes the electric outlet 30 specified by the user. Based on the battery charging information received at the communication unit 40, the acquirer 50 acquires the charge result information of the vehicle 20 of the user charged up with electricity supplied through the electric outlet 30. The acquirer 50 acquires the charge result information for each of multiple electric outlets 30.

When the communication unit 40 receives the locking information from the electricity supply device 10, the deriver 54 derives the amount of payment to the manager of the installation place 100 of the electric outlet 30 based on the charge result information acquired at the acquirer 50. More specifically, based on the charge result information for each of multiple electric outlets 30 acquired at the acquirer 50, the deriver 54 distributes an amount corresponding to the total amount of fees of which billing processing has been performed for multiple users, among the managers of the installation places 100 of the respective electric outlets 30, and sets the amount distributed to each manager as the amount of payment to the manager. For example, the deriver 54 may derive the amount of payment to the manager by substituting, each time the locking information is received, the amount corresponding to the total amount of fees of which billing processing has been performed and the charging time included in the charge result information, into a predetermined calculation formula. The amount corresponding to the total amount of fees of which billing processing has been performed may be an amount obtained by subtracting a profit of the owner of the management server 18 from the total amount, for example. The amounts of payment to the managers may be derived every predetermined period, such as a month, such that the amount distributed to a manager with a longer accumulated charging time is increased, based on the accumulated charge result information during the predetermined period for each manager.

The payment processing unit 56 performs the payment processing for the derived amount of payment to each manager and transmits the payment completion information to a corresponding manager terminal 16 via the communication unit 40. The payment processing unit 56 also transmits the payment completion information to the fee charging server 12 via the communication unit 40. The payment completion information need not necessarily be transmitted to the fee charging server 12. The payment processing may be performed based on a well-known technology.

The configuration of the processing unit 42 may be implemented by a CPU or memory of any given computer, an LSI, or the like in terms of hardware, and by a memory-loaded program or the like in terms of software. In the present embodiment is shown a functional block configuration realized by cooperation thereof. Therefore, it would be understood by those skilled in the art that these functional blocks may be implemented in a variety of forms by hardware only, software only, or a combination thereof.

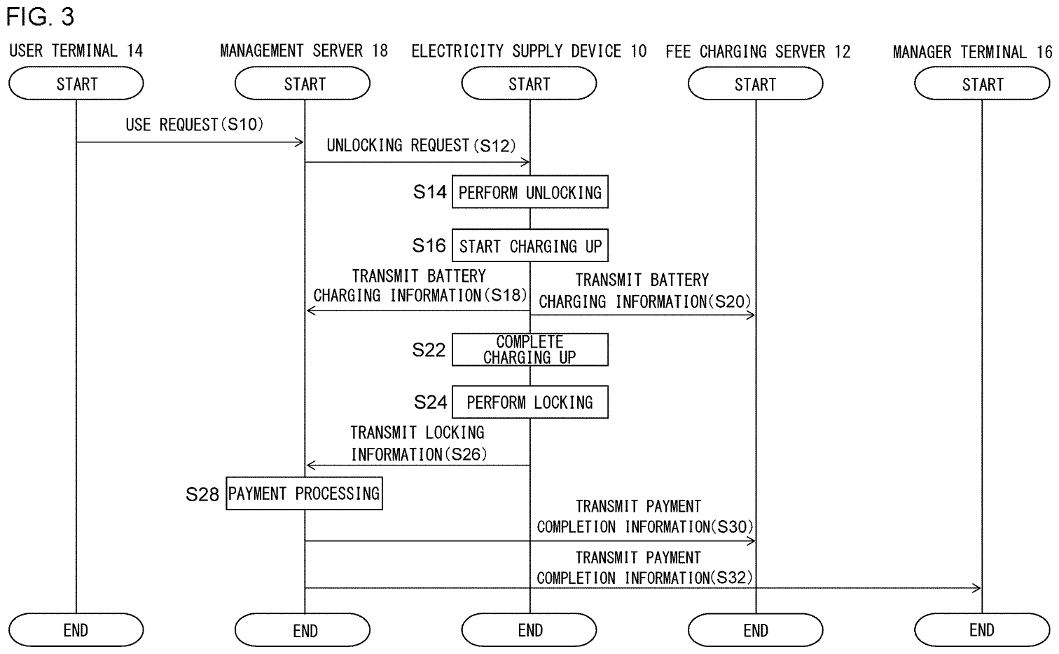

There will now be described the overall operation of the information processing system 1 having the configuration set forth above. FIG. 3 is a sequential diagram that shows processing performed in the information processing system 1 shown in FIG. 1.

First, a user terminal 14 transmits the use request to the management server 18 (S10). According to the use request, the management server 18 transmits the unlocking request to a corresponding electricity supply device 10 (S12). According to the unlocking request, the electricity supply device 10 performs unlocking (S14).

When the user connects the vehicle 20 to the electric outlet 30 with a charging cable, the electricity supply device 10 starts battery charge of the vehicle 20 (S16). During the battery charge, the electricity supply device 10 transmits the battery charging information to the management server 18 (S18) and also transmits the battery charging information to the fee charging server 12 (S20).

The electricity supply device 10 completes the battery charge of the vehicle 20 in a predetermined condition (S22). The electricity supply device 10 then locks the electric outlet 30 (S24) and transmits the locking information to the management server 18 (S26). Upon reception of the locking information, the management server 18 derives an amount of payment to the manager based on the charge result information to perform the payment processing (S28). The management server 18 then transmits the payment completion information to the fee charging server 12 (S30) and also transmits the payment completion information to a corresponding manager terminal 16 (S32).

According to the present embodiment, since the billing processing of a predetermined amount of fee is performed for a user and the amount of payment to the manager is derived based on the charge result information, the payment to the manager can be appropriately performed while flat-rate pricing is employed for the charging to users. Also, since users need not be notified of battery charge conditions, including a unit price, for each battery charge, the users can casually charge up their vehicle batteries without checking the battery charge conditions.

Also, since an amount corresponding to the total amount of fees of which the billing processing has been performed for multiple users is distributed among managers, payment to the managers can be fairly performed.

Further, since an electricity fee for electricity used while the battery charging information is received is derived based on a unit price lower than that applied when the battery charging information is not received, electricity used for battery charge of a vehicle 20 can be provided less expensively.

### Second Embodiment

The second embodiment differs from the first embodiment in that the entire electricity fee of the installation place 100 is charged by the electricity supplier to the manager. In the following, description will be given mainly for the differences from the first embodiment.

The entire electricity fee of the installation place 100 of an electric outlet 30 derived in the fee charging server 12 is charged to the manager every predetermined period, such as once a month. Each manager is charged by an electricity supplier an electricity fee for electricity supplied to a vehicle 20 through an electric outlet 30 of the manager (hereinafter, referred to as a specific electricity fee), together with the electricity fee for other electrical equipment.

The deriver 54 of the management server 18 derives the specific electricity fee during the predetermined period for each manager based on the charge result information for the predetermined period and the second unit price. Instead of deriving, by the deriver 54, the electricity fee, the fee charging server 12 may transmit information on the specific electricity fee to the management server 18, so that the communication unit 40 receives the information and the deriver 54 acquires the specific electricity fee.

For each manager, when the amount distributed to the manager is less than the specific electricity fee charged to the manager, the deriver 54 adds, to the amount of payment to the manager, the difference between the specific electricity fee and the amount distributed to the manager. A situation where the amount distributed to a manager is less than the specific electricity fee charged to the manager may be, for example, the situation where the number of users who have charged up their vehicle batteries during a predetermined period is more than expected, and the accumulated charging time of multiple electric outlets 30 within the predetermined period exceeds a predetermined time.

According to the present embodiment, at least the electricity fee for electricity used for battery charge of a vehicle 20 can be paid to the manager. Therefore, detriment to the manager can be prevented.

Described above is an explanation based on exemplary embodiments. The embodiments are intended to be illustrative only, and it will be obvious to those skilled in the art that various modifications to a combination of constituting elements or processes could be developed and that such modifications also fall within the scope of the present disclosure.

For example, although an example has been described in the first and second embodiments in which the fee charging server 12 derives, based on the second unit price, an electricity fee for a predetermined amount of electricity used while the battery charging information is received, the unit price may be fixed, and the fee charging server 12 may derive the electricity fee based on the first unit price.

In the first embodiment, the management server 18 may perform payment of the electricity fee for electricity used for battery charge to the electricity supplier, each time battery charge for a user is completed. In this case, the deriver 54 derives, in addition to the amount of payment to the manager, the electricity fee for electricity used for battery charge based on the charge result information and the second unit price. Accordingly, the payment processing unit 56 performs the payment processing of the derived electricity fee for the electricity supplier and transmits, to the fee charging server 12 via the communication unit 40, the payment completion information indicating the completion of the payment processing for the electricity supplier. This modification allows greater flexibility in the configuration of the information processing system 1.

What is claimed is:

1. A management server, comprising:
a billing processing unit configured to perform billing processing of a predetermined amount of fee for a user at predetermined timing;
an acquirer configured to acquire charge result information of a vehicle of the user charged up with electricity supplied through an electric outlet; and
a deriver configured to derive an amount of payment to a manager of the installation place of the electric outlet on the basis of the charge result information acquired at the acquirer.

2. The management server of claim 1, wherein:
the billing processing unit performs billing processing of the predetermined amount of fee for each of a plurality of users at the predetermined timing;
the acquirer acquires the charge result information for each of a plurality of electric outlets; and,
on the basis of the charge result information for each of the plurality of electric outlets acquired at the acquirer, the deriver distributes an amount corresponding to the total amount of fees of which billing processing has been performed for the plurality of users, among managers of the installation places of the respective electric outlets, and sets the amount distributed to each manager as an amount of payment to the manager.

3. The management server of claim 2, wherein:
each manager is charged, by an electricity supplier for supplying electricity to the electric outlet, an electricity fee for electricity supplied to the vehicle through the electric outlet; and,
for each manager, when the amount distributed to the manager is less than the electricity fee charged to the manager, the deriver adds the difference between the electricity fee and the amount distributed to the manager, to the amount of payment to the manager.

4. An information processing method, comprising:
performing billing processing of a predetermined amount of fee for a user at predetermined timing;
acquiring charge result information of a vehicle of the user charged up with electricity supplied through an electric outlet; and
deriving an amount of payment to a manager of the installation place of the electric outlet on the basis of the charge result information acquired.

5. An information processing system, comprising:
an electricity supply device; and
a management server configured to communicate with the electricity supply device,
the electricity supply device comprising:
an electric outlet through which electricity supplied from an electricity supplier can be supplied to a vehicle of a user; and
a control device configured to record charge result information of the vehicle charged up with electricity supplied through the electric outlet,
the management server comprising:
a billing processing unit configured to perform billing processing of a predetermined amount of fee for the user at predetermined timing;
an acquirer configured to acquire the charge result information from the control device; and
a deriver configured to derive an amount of payment to a manager of the installation place of the electric outlet on the basis of the charge result information acquired at the acquirer.

6. The information processing system of claim 5, further comprising a fee charging server configured to derive an electricity fee of the installation place of the electric outlet, wherein:
while electricity is supplied to the vehicle through the electric outlet, the control device transmits battery charging information to the fee charging server; and
the fee charging server derives an electricity fee for electricity used while the battery charging information is received, on the basis of a second unit price that is lower than a first unit price applied when the battery charging information is not received.
